(19) United States
(12) Patent Application Publication
(10) Pub. No.: US 2014/0121794 A1
(43) Pub. Date: May 1, 2014

(54) Method, Apparatus, And Computer Program Product For Providing A Personalized Audio File

(71) Applicant: NOKIA CORPORATION, Espoo (FI)

(72) Inventors: Antti Johannes Eronen, Tampere (FI); Jukka Holm, Tampere (FI); Juha Arrasvuori, Tampere (FI); Arto Lehtiniemi, Lempaala (FI); Ojanpera Juha, Nokia (FI)

(73) Assignee: NOKIA CORPORATION, Espoo (FI)

(21) Appl. No.: 13/664,957

(22) Filed: Oct. 31, 2012

(51) Int. Cl. G06F 17/00

(52) U.S. Cl. 700/94

(57) ABSTRACT

A method, apparatus and computer program product is disclosed for providing a personalized audio file. Various recordings of an event or performance may be scored by weighting properties relating to audio quality. The scored properties may include information regarding the quality of a recording device, location or orientation of a recording device relative to a sound source, and/or an amount background noise detected on a recording. Scored properties may be weighted based on provided user preferences, detected user device qualities, and/or user listening environments. A personalized audio file, which may include a combination of audio files or extracted tracks from various audio files, is provided to a user.

### TECHNOLOGICAL FIELD

An example embodiment of the present invention relates generally to providing audio files, and more particularly, to a method, apparatus and computer program product for providing a personalized audio file.

### BACKGROUND

The widespread use of social media paired with the advancement of computing technology and mobile devices has led to an increase in recording live events and sharing the resulting video images and sound recordings. Many users upload audio recordings of musical performances or other events to social media or other sites for peers to listen to. Often times, various mobile device users capture recordings of the same event, providing numerous options to users requesting to listen to the audio recordings.

### BRIEF SUMMARY

A method, apparatus, and computer program product are therefore provided for providing a personalized audio file. A personalized audio file may be provided to a user by calculating a weighted score of various audio recordings based on user preferences.

A method is provided for receiving a request for an audio file associated with an event, identifying a plurality of audio files potentially satisfying the request, receiving user preferences based on audio quality, calculating a personalized score for at least one audio file of the plurality of audio files based on the user preferences and at least one property of the at least one audio file, selecting at least one audio file based on the at least one personalized score, and causing provision of a personalized audio file.

In some embodiments, the at least one property includes a quality of a recording device, a location of a recording device relative to a sound source, an orientation of a recording device relative to a sound source and/or information regarding background noise. In some embodiments, the method may further include combining at least two audio files from the plurality of audio files, and causing provision of the combined audio files as the personalized audio file. The method may include extracting at least one audio track from at least one of the plurality of audio files, and utilizing the extracted track in the personalized audio file.

In some embodiments, an apparatus is provided, comprising a processor and memory, the memory including computer program code configured to receive a request for an audio file associated with an event, identify a plurality of audio files potentially satisfying the request, receive user preferences based on audio quality, calculate a personalized score for at least one audio file of the plurality of audio files based on the user preferences and at least one property of the at least one audio file, select at least one audio file based on the at least one personalized score, and cause provision of a personalized audio file.

In some embodiments, the at least one property may include a quality of a recording device, a location of a recording device relative to a sound source, an orientation of a recording device relative to a sound source and/or information regarding background noise. In some embodiments, the computer program code may be further configured to combine at least two audio files from the plurality of audio files, and cause provision of the combined audio files as the personalized audio file. The computer program code may be further configured to extract at least one audio track from at least one of the plurality of audio files, and utilize the extracted track in the personalized audio file.

In some embodiments, a computer program product is provided comprising at least one non-transitory computer-readable storage medium having computer-executable program code instruction stored therein with the computer-executable program code instructions including program code instructions to receive a request for an audio file associated with an event, identify a plurality of audio files potentially satisfying the request, receive user preferences based on audio quality, calculate a personalized score for at least one audio file of the plurality of audio files based on the user preferences and at least one property of the at least one audio file, select at least one audio file based on the at least one personalized score, and cause provision of a personalized audio file.

In some embodiments, the at least one property may include a quality of a recording device, a location of a recording device relative to a sound source, an orientation of a recording device relative to a sound source and/or information regarding background noise. In some embodiments, the program code instructions may be further configured to combine at least two audio files from the plurality of audio files, and cause provision of the combined audio files as the personalized audio file. The program code instructions may be further configured to extract at least one audio track from at least one of the plurality of audio files, and utilize the extracted track in the personalized audio file.

In some embodiments, an apparatus is provided with means for receiving a request for an audio file associated with an event, identifying a plurality of audio files potentially satisfying the request, receiving user preferences based on audio quality, calculating a personalized score for at least one audio file of the plurality of audio files based on the user preferences and at least one property of the at least one audio file, selecting at least one audio file based on the at least one personalized score, and causing provision of a personalized audio file.

The at least one property may include a quality of a recording device, a location of a recording device relative to a sound source, an orientation of a recording device relative to a sound source and/or information regarding background noise. In some embodiments, the apparatus may further include means for combining at least two audio files from the plurality of audio files, and causing provision of the combined audio files as the personalized audio file. The apparatus may include means for extracting at least one audio track from at least one of the plurality of audio files, and utilizing the extracted track in the personalized audio file.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an audio file personalization apparatus that may be configured to implement example embodiments of the present invention; and

FIG. 2 is a flowchart illustrating operations to provide a personalized audio recording in accordance with one embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such teens should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), may be differentiated from a “computer-readable transmission medium,” which refers to an electromagnetic signal.

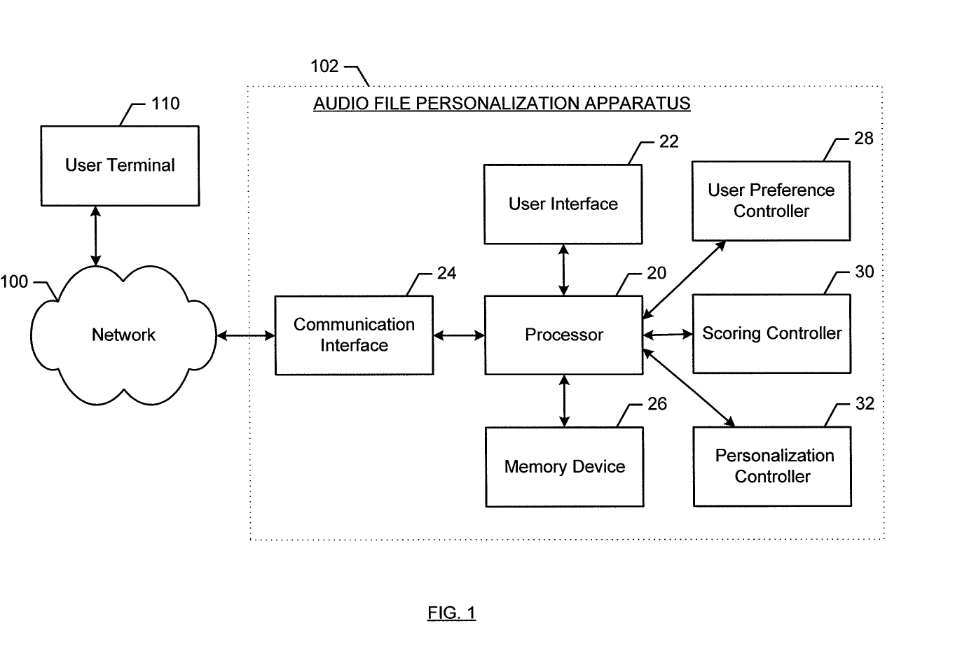

As described below, a method, apparatus and computer program product are provided for scoring audio recordings and providing a personalized audio file to a user. Referring to FIG. 1, audio file personalization apparatus 102 may include or otherwise be in communication with processor 20, user interface 22, communication interface 24, memory device 26, user preference controller 28, scoring controller 30, and personalization controller 32. Audio file personalization apparatus 102 may be embodied by a wide variety of devices including mobile terminals, e.g., mobile telephones, smartphones, tablet computers laptop computers, or the like, computers, workstations, servers or the like and may be implemented as a distributed system or a cloud based entity.

In some embodiments, the processor 20 (and/or co-processors or any other processing circuitry assisting or otherwise associated with the processor 20) may be in communication with the memory device 26 via a bus for passing information among components of the audio file personalization apparatus 102. The memory device 26 may include, for example, one or more volatile and/or non-volatile memories. In other words, for example, the memory device 26 may be an electronic storage device (e.g., a computer readable storage medium) comprising gates configured to store data (e.g., bits) that may be retrievable by a machine (e.g., a computing device like the processor 20). The memory device 26 may be configured to store information, data, content, applications, instructions, or the like for enabling the apparatus to carry out various functions in accordance with an example embodiment of the present invention. For example, the memory device 26 could be configured to buffer input data for processing by the processor 20. Additionally or alternatively, the memory device 26 could be configured to store instructions for execution by the processor 20.

The audio file personalization apparatus 102 may, in some embodiments, be embodied in various devices as described above. However, in some embodiments, the audio file personalization apparatus 102 may be embodied as a chip or chip set. In other words, the audio file personalization apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The audio file personalization apparatus 102 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 26 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal or network entity) configured to employ an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor 20.

Meanwhile, the communication interface 24 may be any means such as a device or circuitry embodied in either hardware or a combination of hardware and software that is configured to receive and/or transmit data from/to a network and/or any other device or module in communication with the audio file personalization apparatus 102. In this regard, the communication interface 24 may include, for example, an antenna (or multiple antennas) and supporting hardware and/or software for enabling communications with a wireless communication network. Additionally or alternatively, the communication interface 24 may include the circuitry for interacting with the antenna(s) to cause transmission of signals via the antenna(s) or to handle receipt of signals received via the antenna(s). In some environments, the communication interface 24 may alternatively or also support wired communication. As such, for example, the communication interface 24 may include a communication modem and/or other hardware/software for supporting communication via cable, digital subscriber line (DSL), universal serial bus (USB) or other mechanisms.

In some embodiments, such as instances in which the audio file personalization apparatus 102 is embodied by a user device, the audio file personalization apparatus 102 may include a user interface 22 that may, in turn, be in communication with the processor 20 to receive an indication of a user input and/or to cause provision of an audible, visual, mechanical or other output to the user. As such, the user interface 22 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor 20 may be configured to control one or more functions of one or more user interface elements through computer program instructions (e.g., software and/or firmware) stored on a memory accessible to the processor 20 (e.g., memory device 26, and/or the like).

In some example embodiments, processor 20 may be embodied as, include, or otherwise control a user preference controller 28 for configuring user preferences regarding the quality of audio files. As such, the user preference controller 28 may be embodied as various means, such as circuitry, hardware, a computer program product comprising computer readable program instructions stored on a computer readable medium (for example, memory device 26) and executed by a processing device (for example, processor 20), or some combination thereof. User preference controller 28 may be capable of communication with one or more of the processor 20, memory device 26, user interface 22, and communication interface 24 to access, receive, and/or send data as may be needed to perform one or more of the user preference configuration functionalities as described herein.

Audio file personalization apparatus 102 may include, in some embodiments, a scoring controller 30 configured to perform functionalities as described herein, such as scoring audio files based on properties of an audio file. Processor 20 may be embodied as, include, or otherwise control the scoring controller 30. As such, the scoring controller 30 may be embodied as various means, such as circuitry, hardware, a computer program product comprising computer readable program instructions stored on a computer readable medium (for example, the memory device 26) and executed by processor 20, or some combination thereof. Scoring controller 30 may be capable of communication with one or more of the processor 20, memory device 26, user interface 22, communication interface 24, and user preference controller 28 to access, receive, and/or send data as may be needed to perform one or more of the functionalities of the scoring controller 30 as described herein. Additionally, or alternatively, scoring controller 30 may be implemented on user preference controller 28. In some example embodiments in which audio file personalization apparatus 102 is embodied as a server cluster, cloud computing system, or the like, user preference controller 28 and scoring controller 30 may be implemented on different apparatuses.

Audio file personalization apparatus 102 may include, in some embodiments, a personalization controller 32 configured to perform functionalities as described herein, such as personalizing an audio recording for a user. Processor 20 may be embodied as, include, or otherwise control the personalization controller 32. As such, the personalization controller 32 may be embodied as various means, such as circuitry, hardware, a computer program product comprising computer readable program instructions stored on a computer readable medium (for example, the memory device 26) and executed by processor 20, or some combination thereof. Personalization controller 32 may be capable of communication with one or more of the processor 20, memory device 26, user interface 22, communication interface 24, user preference controller 28, and/or scoring controller 30 to access, receive, and/or send data as may be needed to perform one or more of the functionalities of the personalization controller 32 as described herein. Additionally, or alternatively, personalization controller 32 may be implemented on user preference controller 28 and/or scoring controller 30. In some example embodiments in which audio file personalization apparatus 102 is embodied as a server cluster, cloud computing system, or the like, user preference controller 28, scoring controller 30, and/or personalization controller 32 may be implemented on different apparatuses. Regardless of implementation, the audio file personalization apparatus 102 may provide the functionalities of the user preference controller 28, scoring controller 30, and/or personalization controller 32 as an audio file personalization service.

Any number of user terminal(s) 110 may connect to audio file personalization apparatus 102 via a network 100. User terminal 110 may be embodied as a mobile terminal, such as personal digital assistants (PDAs), pagers, mobile televisions, mobile telephones, gaming devices, laptop computers, tablet computers, cameras, camera phones, video recorders, audio/video players, radios, global positioning system (GPS) devices, navigation devices, or any combination of the aforementioned, and other types of voice and text communications systems. The user terminal 110 need not necessarily be embodied by a mobile device and, instead, may be embodied in a fixed device, such as a computer or workstation. Network 100 may be embodied in a local area network, the Internet, any other form of a network, or in any combination thereof, including proprietary private and semi-private networks and public networks. The network 100 may comprise a wire line network, wireless network (e.g., a cellular network, wireless local area network, wireless wide area network, some combination thereof, or the like), or a combination thereof, and in some example embodiments comprises at least a portion of the Internet. As another example, a user terminal 110 may be directly coupled to an audio file personalization apparatus 102.

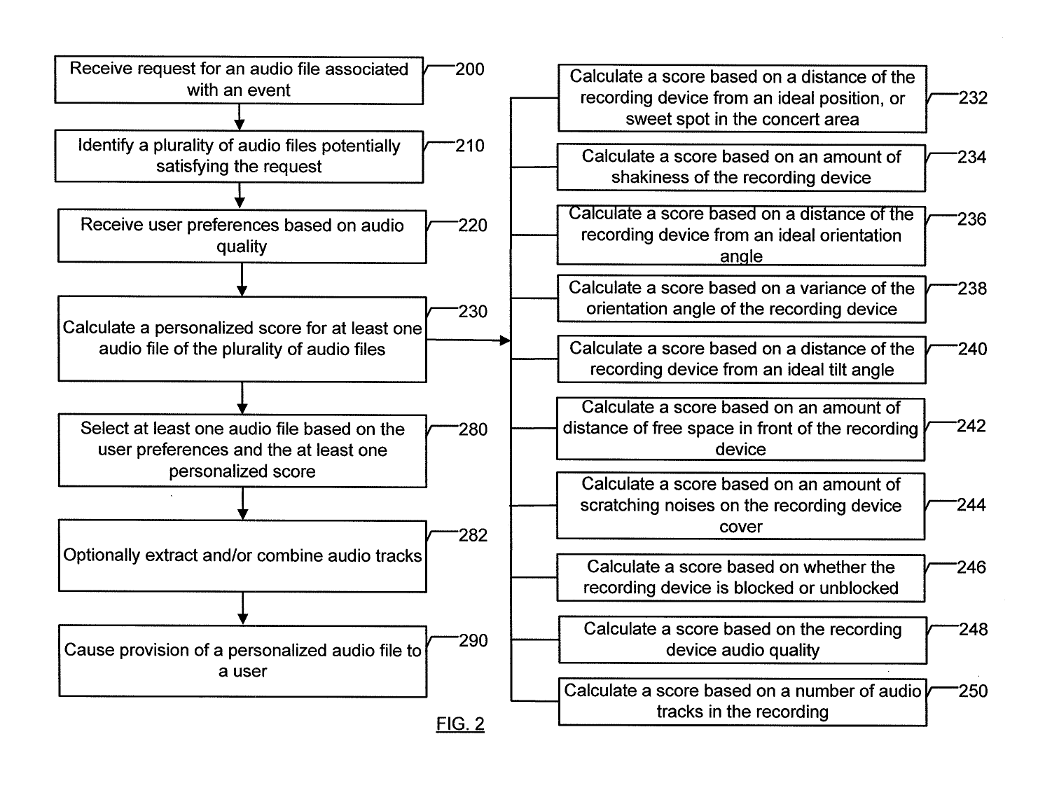

Referring now to FIG. 2, the operations for scoring audio recordings and providing a personalized audio file are outlined in accordance with an example embodiment. In this regard and as described below, the operations of FIG. 2 may be performed by the user preference controller 28, scoring controller 30, and/or personalization controller 32. At operation 200, the audio file personalization apparatus 102 may receive a request for an audio file associated with an event, by communication interface 24, user interface 22, or processor 20, for example. The request may be originated at a user terminal 110 and transmitted to the audio file personalization apparatus 102 over a network 100. The request may include a request to listen to a particular performance or event, or any other information that may be used to identify an audio file.

At operation 210, audio file personalization apparatus 102 may identify, by processor 20, a plurality of audio files potentially satisfying the request. Such files may be stored on memory device 26, for example. Scenarios in which multiple audio files potentially satisfy the request may be those in which various users and/or devices recorded the same event or performance, and/or any situation where multiple audio files exist for a single event. The audio files may be separate audio files associated with the same event on memory device 26, for example. It will also be appreciated that some or all of the audio files may be captured as a part of a video recording.

At operation 220, audio file personalization apparatus 102, such as by user preference controller 28, may receive user preferences based on audio quality. Such preferences may be retrieved from memory device 26, for example, in scenarios in which a user has previously provided preferences. In some embodiments, a user may provide the preferences upon requesting an audio file. Example preferences may include the technical quality of the user's media playback device (for example, stereo vs. 5.1 surround), or the user's listening context, such as listening to an audio file while at home or while traveling on a train. Another example of a preference may be a user's preference regarding the sounds of a recording and background noise. Some users may prefer a “pure audio” recording or high audio quality, with no or little audience noise, while others may prefer a “live feeling” or low audio quality, with audience noise and event location ambience. In addition to the user preferences a user provides, a ranking or weighing of importance may be provided, so that a user may indicate which features are most and/or least important in selecting an appropriate audio file. In some embodiments, user preferences may refer to preferences established by a group of users. In some embodiments, the user preferences, such as the weighing of different features, may be learned by the service over time as the user uses the service. For example, the service may collect user feedback, in the form of good/bad or thumbs up/thumbs down ratings, and use this information to learn what features are important for this particular user. Another example of input from the user may be skipping behavior which is a form of collecting implicit user feedback: if the user skips the audio track indicating that he did not like it (or it did not fit the listening context well), the system may learn that the features which were prominent in the audio file provided for the user did not match well with his profile or listening context.

Continuing to operation 230, audio file personalization apparatus 102 may include means, such as scoring controller 30, processor 20, or the like, for calculating a personalized score for at least one audio file of the plurality of potentially satisfying the request. In this regard, properties of an audio file may be scored, and weighted according to personal preference. The properties of the audio file may be associated with the audio file, and stored on memory device 26, for example. Such properties may be detected at the time of recording, and uploaded to the audio file personalization apparatus 102. Sensor data may be obtained from components of the recording device such as a Global Positioning System (GPS), digital compass, accelerometer, gyroscope, and/or mobile radar technology. Additionally or alternatively, the properties may be provided by a recorder of the file, or another user upon uploading the file, and/or provided by a user upon listening to the file and personally assessing the sound quality and/or properties. Scoring controller 30 may access and retrieve the properties associated with the audio files. Operations regarding calculating scores based on properties of the audio file are described with respect to operations 232-250.

Properties associated with an audio file may include various features indicative of a quality of a recording device, location of a recording device relative to a sound source, orientation of a recording device relative to a sound source, information regarding undesired noise, and/or the type of music recorded, for example. More specifically, at operation 232, the scoring controller 30 may calculate a score based on a distance from a mixing table or another ‘sweet spot” in the event area. For example, the best sound quality in a live concert situation may be near a mixing table in the concert area. Here, the various instruments may be most balanced, and the speaker system may provide optimal audio qualities such as loudness and spectral balance. Therefore, a recording device closest to the mixing table at any given time of a concert may provide the highest quality recording.

Various methods may be used to estimate the proximity to the mixing table. In some embodiments, recording devices may perform Bluetooth™ scans when recording an event. The results of the Bluetooth™ scan may be uploaded with the audio recording. The Bluetooth™ device near the mixing table may be, for example, a Bluetooth™ device commonly used by mixers such as a mixing console or a device controlling the mixing console. Additionally or alternatively, a phone Bluetooth™ device identifier of the sound engineer may be used. The sound engineer personality may be obtained from a concert organizer web page or tweets™ (crawled from the short text messages written using the Twitter™ Internet service) from the concert participants.

The device which sees the strongest signal of a Bluetooth™ device known to have the closest proximity to the mixing table may be assigned the highest score. Another possible scoring method may be to rank the device, such that the device with the largest signal strength gets the rank 1, the device with the second largest signal gets the rank 2, and so on.

Additionally or alternatively, users present at the event may upload the location (as GPS coordinates) of the mixing table to the audio file personalization service. A recording device may also capture a location as GPS coordinates while recording audio and/or video. The scoring controller 30 may give the highest score to the sound track from the device whose location is closest to the submitted mixing table coordinates.

The mixing desk location score may depend on the location of the mixing desk in the event venue. If the mixing table is in the middle of the audience, the audio system and instrument balance may be adjusted to be ideal there. This may be the case particularly in outdoor events such as rock festivals. In some event venues, such as indoor clubs and some outdoor events, the mixing table may be on the stage. In this case, it may not desirable to give a high score based on the proximity of the mixing table but rather to omit the score completely, or rather give a negative score based on mixing table proximity. Users may submit this type of information to the audio file personalization service to indicate whether the mixing table was in the middle of the audience or on the stage. Additionally or alternatively, the scoring controller 30 may consult a database of event venue floor plans may be consulted. Bluetooth™ scanning results may be analyzed to determine whether the nearby Bluetooth™ devices are devices commonly used by musicians, mixers, and/or sound engineers. If devices belonging to any of these groups are present, then it may be likely that the mixing table is on the stage rather than in the middle of the audience.

It will be appreciated that an ideal location does not need to be limited to the vicinity of the mixing table but that a score based on location may also measure the proximity of a recording device to some other ideal location. For example, if the scoring controller 30 or user preference controller 28 observes that some users who are known as an audiophile (high fidelity or HIFI—enthusiast) or for having HIFI or music as their hobby (taken, for example from their personal profile in the audio file personalization or some other social networking service which can be connected by the audio file personalization service), then the user may place themself for optimal audio quality at a performance. Furthermore, the audio file personalization apparatus 102 may store the most common locations of these audiophile persons during the concert on memory device 26, for example, so that the scoring controller 30 may favor audio tracks captured close to the locations of the audiophile persons. Note that the audiophile persons do not necessarily need to capture the audio themselves, but they may be carrying a device capable of communicating their location to the audio file personalization apparatus 102 during the event, and another user may capture the actual audio file.

In addition to scoring an audio file based on the recording device distance from an ideal position, the scoring controller 30, at operation 234, may score an audio file based on the amount of shakiness of a device during the recording. This may be estimated, for example, as the root-mean-square (rms) value of the device accelerometer signal magnitude in frames. The accelerometer signal magnitude rms values for audio tracks may be sorted, and the audio file with the smallest value may get the rank 1, or a high score, for example.

The scoring controller 30 may also calculate a score based on the distance of the recording device from an ideal orientation angle, as shown by operation 236. The audio file personalization apparatus 102 may access a model of the event setting, stored on memory device 26, for example, and indicating the direction of the stage from the location corresponding to the mixing table. The compass orientation from the mixing table towards the event stage may correspond to an ideal orientation angle, and the absolute difference in degrees may thus be used as a distance. The scoring controller 30 may assign a higher score to a device having the smallest absolute difference in degrees from the ideal orientation angle. In addition to or instead of using a model of the event setting, the scoring controller 30 may in some cases estimate the ideal direction as the most common compass orientation of the devices. This rough approximation could be used if a model of the event setting is not available. The scoring controller 30 may additionally or alternatively calculate a score based on the variance of the orientation angle, as shown by operation 238. If the user pans a device left and right during a performance, this may create annoying effects of the audio scene (the center of the audio scene also moving left or right along with the panning movement). One measure may relate to the variance of the orientation angle over time. Therefore, an audio recording taken from a device with the smallest orientation angle variance may receive a higher score from the scoring controller 30.

Similarly, at operation 240, the scoring controller 30 may calculate a score based on a distance of a recording device from an ideal tilt angle to score an audio file. The tilt angle may be defined as the angle between the horizontal direction and the line passing through the device optics. In most cases, the ideal tilt angle would be horizontally or slightly tilted upwards, as the stage may be higher than the ground level in concerts. The absolute distance in degrees from an ideal tilt angle may be scored, with an audio track having been recorded with a device pointing closest to an ideal tilt angle receiving a high score.

At operation 242, the scoring controller 30 may additionally or alternatively calculate a score for an audio file based on an estimate of free space in front of a recording device. If a laser distance sensor or other sensor providing distance to the nearest object in front of the device is available, then preferably the distance to the nearest object in front of the device should be close to an estimate of the distance from the mixing table to the stage. In particular, the distance to the nearest object should not be very close, as this may indicate that something is blocking the path between the stage and recording device. The device for which the estimated distance to the nearest object is closest to an estimated distance to the stage may receive a high score.

At operation 244, the scoring controller 30 may calculate a score based on an amount of scratching noises on the device cover. If the user is scratching the device cover, the audio quality may not be ideal. In particular, some embodiments may include a scratching noise detection system, where a trained audio classifier may detect the typical scratching noises that may occur on a device cover. The audio files may be ranked according to a probability of containing scratching noise, and the audio clip with the lowest probability of having scratching noises may be assigned a high score.

Continuing to operation 246, the scoring controller 30 may calculate a score based on whether the recording device is blocked or unblocked. If the front the recording device is blocked, the result may be undesired muted high frequencies in the audio recording. The proximity sensor reading may indicate whether there is something blocking the device in front or not. Audio files captured by recording devices where the proximity sensor reading may indicate that the device is unblocked may get a high score whereas devices where something is blocking the device may get a lower score.

At operation 248, the scoring controller 30 may calculate a score based on a recording device audio quality. Some devices may be known to have good audio quality, and the scoring controller 30 may score highest the audio file from a device which has the best audio quality, and the lowest to a recording taken from a device with a low audio quality. A recording device may be identified implicitly by audio file personalization apparatus 102, or provided by a user while uploading a recording.

At operation 250, the scoring controller 30 may calculate a score based on the number of audio tracks in the recording. Some devices may capture mono and/or stereo sound, while some devices capture surround sound with three or more audio channels. A surround recording with multiple tracks may be given a higher score than a stereo recording.

Returning to operation 230, having now scored individual properties of an audio file, the scoring controller 30 may calculate a personalized score for at least one audio file of the plurality of audio files identified as potential matches to a user request. The scoring controller 30 may access user preferences (as described in regard to operation 220), directly on memory device 26, or from the user preference controller 28, for example. Based on user preferences and the individual scores calculated in regard to operations 232-250, an overall weighted score for an audio file may be calculated. Features found to be most important to a user may be weighted more heavily than those found to be less important to a user. Therefore, the weighted score of an audio file may be considered a personalized score.

In some embodiments, a personal weight vector may be communicated from a user terminal 110 to the audio file personalization apparatus 102, via network 100 and communication interface 24, for example. The scoring controller 30 may perform personalized ranking of the audio files using the weights in the personal weight vector. That is, the value of each of the scores may be multiplied with the appropriate weight from the weight vector, and the final score may be a sum of the weighted scores. The weight vector may contain weights which are appropriate for the listener and for his listening situation. As a result of this, some properties which may determine more relevant for a particular listener and his listening situation may be weighted more than others.

The values of different scores may be normalized on a range between −1 and 1, for example. In some embodiments, the weights could be negative, which may cause the effect of the score to affect in the opposite direction. For example, the original score might measure the amount of distortion in the audio signal, on a normalized scale from −1 to 1, with −1 denoting maximum amount of distortion (worst score) and 1 the minimum amount of distortion (best). When a weight of −1 is applied, the maximum score for an audio file based on the amount of distortion may be obtained by an audio file having the amount of distortion scored by −1 (−1*−1=1). Such an example might be valid, for example, in certain stylistic situations, for example, if the music is grange, and a lower audio quality may be acceptable. A higher audio quality may be preferable for a classical music concert recording.

According to some embodiments, if a user is in a noisy environment, the personalized weight may indicate that audio recordings containing high amount of compression may be preferred over audio tracks with high dynamics, as the quiet sections of high dynamic audio files may not be audible. Additionally or alternatively, the personalized weights may depend on the characteristics of the user's listening device. If the user is listening with a high quality HIFI system, then high quality audio tracks with a wide spectral bandwidth are preferred. If the user is listening with a poor quality device, audio tracks with emphasis on low frequencies, for example, may be preferred as they may be better fitted to the less than ideal rendering capabilities of the low quality user device.

In some embodiments, the personal weights may be determined automatically based on the user's previous media consumption history, the technical capabilities of his media playback device, and/or the contextual factors (like background noise) of the user's listening situation. The user may also explicitly define a preferred “listening profile” that influences the weights, such as described in operation 220. In one example embodiment of the invention, the audio file personalization apparatus 102 may provide a slider, such as by user interface 22 and/or communication interface 24 (to user terminal 110) that allows a user to define in the received audio stream the balance between “pure audio” (i.e. completely without audience noise and event location ambience, or a high audio quality) and “live feeling” (i.e. with audience noise and event location ambience mixed in, or a low audio quality).

It will be appreciated that operations 232-250 provide score calculations for example properties that may be used to calculate a personalized score for an audio track. Additional factors may be accounted for in scoring an audio file, such as a type of music associated with an audio file. For example, as described above, a lower audio quality recording of a Grunge concert may be acceptable, while a higher audio quality may be preferable for a classical music concert recording.

At operation 280, audio file personalization apparatus 102 may include means, such as personalization controller 32, or processor 20, or the like, to select at least one audio file to provide to a the user. In some embodiments, the selected audio file may be the audio file with the highest personalized scored. In some embodiments, the selecting of an audio file may involve additional customization beyond selecting one audio file for a user. At operation 282, audio tracks may be extracted and/or combined to provide a personalized recording for a user. In some embodiments, a multichannel recording may be available. In a multichannel recording, the audio file personalization apparatus 102, such as by processor 20, or personalization controller 32, may estimate the amount of audience cheering or other background noise in the audio files captured by different devices. The sound recording(s) from a device(s) with the most amount of audience cheering may be mixed in a rear channel(s). The recording(s) from a device(s) closest to the mixing table (with less audience cheering) may be mixed in the front channels. From a surround sound recording, the front channels (mostly music) may be extracted, and the rear channels (mostly ambient sound such as audience cheering) may be unused.

Similarly, in a theatre environment, there may be no amplified sound (thus, no mixing desk) and multiple actors may speak from different locations across the stage. In this embodiment, the mixing score may be replaced by a score which depends on the distance to the actor speaking at that moment. The device closest to the currently speaking actor may receive the largest score. The associated audio recording may be down-mixed into mono and placed to the center channel, while audio from other recording devices (capturing the ambience and audience reactions) are mixed to the left, right, and rear channels. This embodiment may be suitable also for example to optimally record the audio from panel discussions at conferences.

Additionally or alternatively, various audio files may be selected for different temporal ranges. A weighted score may not only be calculated for an audio file in its entirety, but some audio files may be segmented, with the various segments scored accordingly. Some audio files may incur only a short time period of poor quality to do a one-time interference or similar occurrence. Therefore, the audio file personalization apparatus 102 may include means, such as processor 20 or scoring controller 30 to take such inconsistencies into account, and may additionally consider the user preferences in determining the significance of such a disturbance in an audio recording. In another example embodiment, a high quality audio file may be available for only a portion of a performance. In such an instance, the personalization controller 32 may provide an audio file to a user having a high personalized score for a portion of a performance, and an additional audio file having the next best personalized score when the first audio file is no longer available to cover the remainder of the performance.

Thus, any number of audio recordings and/or tracks may be used to provide a personalized audio file to a user. Audio file personalization apparatus 102 may cause provision of the personalized audio file via communication interface 24, and network 100, for example, and the user may listen to the personalized audio recording on user terminal 110.

As described above, FIGS. 2 and 3 illustrate flowcharts of operations performed by an audio file personalization apparatus 102. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 26 of an audio file personalization apparatus 102 employing an embodiment of the present invention and executed by a processor 20 of the audio file personalization apparatus 102. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-22. (canceled)

23. A method comprising:
receiving a request for an audio file associated with an event;
identifying a plurality of audio files potentially satisfying the request;
receiving user preferences based on audio quality;
calculating a personalized score for at least one audio file of the plurality of audio files based on the user preferences and at least one property of the at least one audio file;
selecting at least one audio file based on the at least one personalized score; and
causing, with a processor, provision of a personalized audio file.

24. The method of claim 24, wherein the at least one property includes a quality of a recording device.

25. The method of claim 24, wherein the at least one property includes a location of a recording device relative to a sound source.

26. The method of claim 24, wherein the at least one property includes an orientation of a recording device relative to a sound source.

27. The method of claim 24, wherein the at least one property includes information regarding background noise.

28. The method of claim 24, further comprising:
combining at least two audio files from the plurality of audio files; and
causing provision of the combined audio files as the personalized audio file.

29. The method of claim 24, further comprising:
extracting at least one audio track from at least one of the plurality of audio files; and
utilizing the extracted track in the personalized audio file.

30. An apparatus comprising at least one processor and at least one memory including computer program code, the at least one memory and the computer program code configured to, with the processor, cause the apparatus to at least:
receive a request for an audio file associated with an event;
identify a plurality of audio files potentially satisfying the request;
receive user preferences based on audio quality;
calculate a personalized score for at least one audio file of the plurality of audio files based on the user preferences and at least one property of the at least one audio file;
select at least one audio file based on the at least one personalized score; and
cause provision of a personalized audio file.

31. The apparatus of claim 30, wherein the at least one property includes a quality of a recording device.

32. The apparatus of claim 30, wherein the at least one property includes a location of a recording device relative to a sound source.

33. The apparatus of claim 30, wherein the at least one property includes an orientation of a recording device relative to a sound source.

34. The apparatus of claim 30, wherein the at least one property includes information regarding background noise.

35. The apparatus of claim 30, wherein the at least one memory and the computer program code are further configured to, with the processor, cause the apparatus to at least:
combine at least two audio files from the plurality of audio files; and
cause provision of the combined audio files as the personalized audio file.

36. The apparatus of claim 30, wherein the at least one memory and the computer program code are further configured to, with the processor, cause the apparatus to at least:
extract at least one audio track from at least one of the plurality of audio files; and
utilize the extracted track in the personalized audio file.

37. A computer program product comprising at least one non-transitory computer-readable storage medium having computer-executable program code instructions stored therein, the computer-executable program code instructions comprising program code instructions to:
receive a request for an audio file associated with an event;
identify a plurality of audio files potentially satisfying the request;
receive user preferences based on audio quality;
calculate a personalized score for at least one audio file of the plurality of audio files based on the user preferences and at least one property of the at least one audio file;
select at least one audio file based on the at least one personalized score; and
cause provision of a personalized audio file.

38. The computer program product of claim 37, wherein the at least one property includes a quality of a recording device.

39. The computer program product of claim 37, wherein the at least one property includes a location of a recording device relative to a sound source.

40. The computer program product of claim 37, wherein the at least one property includes an orientation of a recording device relative to a sound source.

41. The computer program product of claim 37, wherein the at least one property includes information regarding background noise.

42. The computer program product of claim 37, wherein the computer-executable program code instructions further comprise program code instructions to:
combine at least two audio files from the plurality of audio files; and
cause provision of the combined audio files as the personalized audio file.

43. The computer program product of claim 37, wherein the computer-executable program code instructions further comprise program code instructions to:
extract at least one audio track from at least one of the plurality of audio files; and
utilize the extracted track in the personalized audio file.
